(19) United States
(12) Patent Application Publication
(10) Pub. No.: US 2023/0004653 A1
(43) Pub. Date: Jan. 5, 2023

(54) COMPUTER-READABLE RECORDING MEDIUM STORING PROGRAM, METHOD OF DETECTING VULNERABILITY, AND INFORMATION PROCESSING APPARATUS

(71) Applicant: FUJITSU LIMITED, Kawasaki-shi (JP)

(72) Inventors: Akihiro SHIRAISHI, Ota (JP); Takahiro FURUKI, Kawasaki (JP); Koutarou NOYAMA, Kawaguchi (JP)

(73) Assignee: FUJITSU LIMITED, Kawasaki-shi (JP)

(21) Appl. No.: 17/718,776

(22) Filed: Apr. 12, 2022

(30) Foreign Application Priority Data
Jul. 1, 2021 (JP) 2021-110247

(51) Int. Cl. G06F 21/57; G06F 21/55; G06F 21/56; G06F 8/71

(52) U.S. Cl. CPC G06F 21/577; G06F 21/554; G06F 21/565; G06F 8/71

(57) ABSTRACT

A process includes obtaining update history information that includes respective update histories of a plurality of versions of software, the plurality of versions including a first version immediately previous to a second version, identifying, from the update history information, second version that corresponds to the update history that includes a predetermined keyword, identifying, based on development history information that includes a change location in a source code of the software between the first version and the second version, a code block deleted from the source code when the first version is upgraded to the second version, as the code block that includes a possibility of including vulnerability, and detecting, out of the plurality of versions, a third version that includes the identified code block in the source code.

### CROSS-REFERENCE TO RELATED APPLICATION

This application is based upon and claims the benefit of priority of the prior Japanese Patent Application No. 2021-110247, filed on Jul. 1, 2021, the entire contents of which are incorporated herein by reference.

### FIELD

The embodiments discussed herein are related to a computer-readable recording medium storing a program, a method of detecting vulnerability, and an information processing apparatus.

### BACKGROUND

Today, various types of software are used. Use of software involves a risk of vulnerability. Vulnerability of software may occur due to problems in a program, mistakes in the design at the time of software development, and so forth. Vulnerability of software leads to degradation in security of a device that executes the software. The device that executes the software having the vulnerability may be subjected to, for example, an attack that exploits the vulnerability.

In the development of the software, an edition (version) of the software may be updated by adding a new function to the software or remediating vulnerability of the software. Thus, systems to control updates of software has been considered.

For example, there is a proposal for a method of performing centralized control of statuses of individual programs by recording, in a version control table, a delivery state of each program, versions of the program stored in production source, a fixation information table number of the program to be captured at the time of release, and so forth.

Also, there is a proposal of an apparatus that controls versions of electronic resources such as electronic documents and programs with a tree structure and performs control by classifying derivative relationships between the versions of the resources into two types, continuation and branch. In this way, this apparatus controls version groups formed based on the continuation relationship.

Also, there is a proposal of a problem control system for development and maintenance of software, an apparatus, or the like in which a plurality of control targets related to each other are generated by adding an improvement. This system includes a problem control apparatus which controls problems generated in each control target and a configuration control apparatus which controls a configuration and a change history of the control target. According to this proposal, an edition (version) number is presented as an example of a name of the control target.

Also, there is a proposal of a file configuration control apparatus. With this apparatus, when a status of a file included in a system is checked, the file to be checked is searched from a file information table and update information of the file is searched from an update information table so as to display that update has occurred in another file having a derivative relationship with the file to be checked.

Meanwhile, today, ready made software such as open source software (OSS) is often used for development of software. For example, part of functions in a software product may be implemented by using the OSS. In this case, a developer of the software may check a responding status of vulnerability or the like by referring to a document related to an update publicized for ready made software which is a utilization candidate.

Japanese Laid-open Patent Publication Nos. 9-97171, 11-327980, 2002-108610, and 2007-279883 are disclosed as related art.

### SUMMARY

According to an aspect of the embodiments, a non-transitory computer-readable recording medium storing a program for causing a computer to execute a process, the process includes obtaining update history information that includes respective update histories of a plurality of versions of software, the plurality of versions including a first version immediately previous to a second version, identifying, from the update history information, the second version that corresponds to the update history that includes a predetermined keyword, identifying, based on development history information that includes a change location in a source code of the software between the first version and the second version, a code block deleted from the source code when the first version is upgraded to the second version, as the code block that includes a possibility of including vulnerability, and detecting, out of the plurality of versions, a third version that includes the identified code block in the source code.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an information processing apparatus according to a first embodiment;

FIG. 2 is a diagram illustrating an example of hardware of an information processing apparatus according to a second embodiment;

FIG. 3 is a diagram illustrating an example of the functions of the information processing apparatus;

FIG. 4 is a diagram illustrating an example of a version tree;

FIG. 5 is a diagram illustrating an example of a vulnerability table;

FIG. 6 is a diagram illustrating an example of a vulnerability remediation table;

FIG. 7 is a diagram illustrating an example of a vulnerability list table;

FIG. 8 is a diagram illustrating an example of an update history list table;

FIG. 9 is a diagram illustrating an example of vulnerability solution detection rule information;

FIG. 10 is a diagram illustrating an example of a vulnerability influence list table;

FIG. 11 is a diagram illustrating an example of a fixation file;

FIG. 12 is a diagram illustrating an example of a vulnerability influence presence/absence list table;

FIG. 13 is a diagram illustrating an example of a vulnerability correspondence tree display screen;

FIG. 14 is a flowchart illustrating an example of processing of the information processing apparatus;

FIG. 15 is a flowchart illustrating an example of a vulnerability information obtaining process;

FIG. 16 is a flowchart illustrating an example of a suspected code block identification process;

FIG. 17 is a flowchart illustrating an example of a suspected code block scanning process; and

FIG. 18 is a flowchart illustrating an example of a vulnerability correspondence tree creation process.

### DESCRIPTION OF EMBODIMENTS

In many cases, documents related to updates publicized for ready made software that is utilization candidates do not describe in detail specific update contents such as fixed locations of the software. For this reason, there is a problem in that, even when it is understood that vulnerability has been remediated in a certain version, it is difficult to check whether a version other than the certain version includes the vulnerability. For example, it is conceivable that an information processing apparatus performs reproduction testing on all the versions of the software for the checking. However, the reproduction testing for all the versions is costly.

Hereafter, embodiments of a technique with which a version including vulnerability may be efficiently determined will be described with reference to the drawings.

### First Embodiment

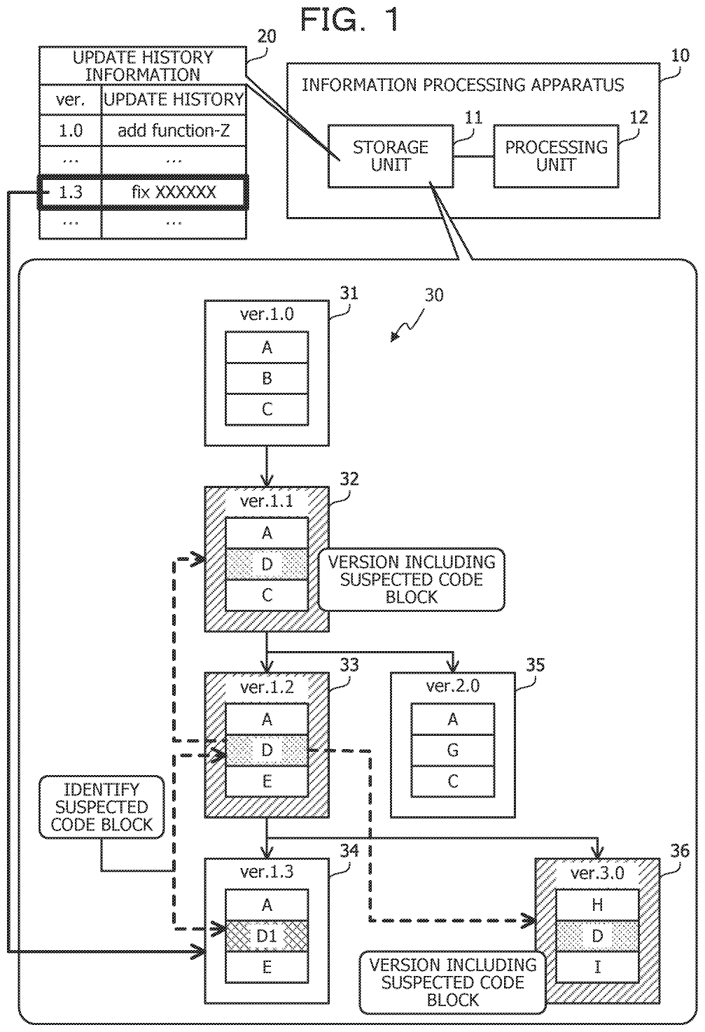

FIG. 1 is a diagram illustrating an information processing apparatus according to a first embodiment. An information processing apparatus 10 assists in checking a version including vulnerability out of a plurality of versions of software. The information processing apparatus 10 includes a storage unit 11 and a processing unit 12.

The storage unit 11 may be a volatile storage device such as a random-access memory (RAM) or may be a non-volatile storage device such as a hard disk drive (HDD) or a flash memory. The processing unit 12 may include a central processing unit (CPU), a digital signal processor (DSP), an application-specific integrated circuit (ASIC), a field-programmable gate array (FPGA), or the like. The processing unit 12 may be a processor that executes a program. The “processor” may include a set of multiple processors (multiprocessor).

The storage unit 11 stores update history information 20 and development history information 30. The update history information 20 includes an update history of each of a plurality of versions of checking target software. The update history is information that describes, for each version of the checking target software, a function added in the version, vulnerability remediated in the version, and so forth. The version may be referred to as an edition, an edition number, or the like. The checking target software may be open source software (OSS) or software other than the OSS. The update history information 20 may be, for example, information publicized by another information processing apparatus that publicizes found vulnerability for various types of software.

For example, the update history information 20 includes items including a version (abbreviated as “ver.”) and the update history. In the item of “ver.”, the versions of the software are registered. In the item of the update history, description of a function added to the corresponding versions or vulnerability remediated in the corresponding versions is registered. For example, a record of ver. “1.0” and the update history of “add function-Z” in the update history information 20 indicates that the function of “function-Z” has been added in version “1.0” of the checking target software. A record of ver. “1.3” and the update history of “fix XXXXXX” in the update history information 20 indicates that the vulnerability of “XXXXXX” has been remediated in version “1.3” of the software.

The development history information 30 is information that indicates a history of development of the checking target software. For each version of the checking target software, the development history information 30 includes information on a program change location in the version. The program change location refers to a location where a source code of the software is changed. For example, the program change location is a location added to or deleted from the source code in the version.

The development history information 30 may be, for example, information publicized by another information processing apparatus that controls repository of the source code for various types of software. A change location of the source code is recorded in a predetermined unit or granularity in the development history information 30. The unit of the change location of the source code may be, for example, a unit of commit. The commit refers to operation of reflecting a change location in the source code in the repository. A change location corresponding to the commit is, for example, a portion reflected in the source code by a single operation of the commit. A portion of the source code identified in the unit of the change location is referred to as a code block.

The development history information 30 may include information on an order relationship between a certain version and the next version. Two or more versions may derive from a single version. Alternatively, the information on the order relationship may be included in the update history information 20.

For example, regarding certain software which is a checking target for the vulnerability, the development history information 30 includes information indicative of sets of source code 31, 32, 33, 34, 35, and 36. As an example, in the development history information 30, the sets of source code 31 to 36 are respectively associated with the following versions. The set of source code 31 is associated with version “1.0”. The set of source code 32 is associated with version “1.1”. The set of source code 33 is associated with version “1.2”. The set of source code 34 is associated with version “1.3”. The set of source code 35 is associated with version “2.0”. The set of source code 36 is associated with version “3.0”.

The information on the order relationships included in the development history information 30 or the update history information 20 indicates the following order relationships regarding the versions for the sets of source code 31 to 36. The set of source code 32 is the next version to the set of source code 31. The sets of source code 33 and 35 are the next versions to the set of source code 32. The sets of source code 34 and 36 are the next versions to the set of source code 33. The order relationships of the sets of source code 31 to 36 with the versions may be represented by a graph having a tree structure in which the versions are set as nodes and the nodes are coupled by edges extending from one version to the next version.

The processing unit 12 obtains the update history information 20 and the development history information 30 and stores the update history information 20 and the development history information 30 in the storage unit 11. For example, upon accepting designation of the checking target software for vulnerability from a user, the processing unit 12 obtains the update history information 20 and the development history information 30 related to the designated software from another information processing apparatus and executes the following processing.

The processing unit 12 identifies, from the update history information 20, a version corresponding to an update history including a predetermined keyword. The predetermined keyword is, for example, a term indicating that vulnerability have been remediated. For example, the predetermined keyword may be a predetermined word such as “fix”, “solve”, or “patch” indicative of program modification as exemplified by “fix XXXXXX” described above or may be keywords that are, for example, a combination of the word and specific identification information indicative of vulnerability. Examples of the specific identification information indicative of vulnerability include, for example, a common vulnerabilities and exposures-identifier (CVE-ID). It is conceivable that specific identification information indicative of vulnerability may be other information such as an identifier (JVN# or JVNVU#) of vulnerability information published in Japan Vulnerability Notes (JVN). Alternatively, the predetermined keyword may be keywords that are a combination of words such as a word representative of vulnerability and “fix” or “solve”. It is conceivable that examples of terms representative of vulnerability may include names of attacks that abuse vulnerability such as “brute force”, “distributed denial of service (DDos)”, and “cross site scripting”, a word meaning vulnerability such as “vulnerability”, “exploit”, and the like. Information indicative of predetermined keywords is stored in the storage unit 11 in advance.

For example, the processing unit 12 identifies, based on the update history information 20, version “1.3” as a version corresponding to an update history including a predetermined keyword. Based on the development history information 30, the processing unit 12 identifies a code block deleted when a version immediately previous to the identified version is upgraded to the identified version as a code block that may include vulnerability. A code block that may include vulnerability is referred to as a suspected code block. The code block deleted when the version immediately previous to the identified version is upgraded to the identified version is a code block that exists in the set of source code of the immediately previous version but is deleted from the set of source code of the identified version.

For example, based on the order relationship between the versions, the processing unit 12 identifies the immediately previous version “1.2” with respect to the identified version “1.3”. By comparing the set of source code 33 of version “1.2” with the set of source code 34 of version “1.3”, the processing unit 12 identifies the code block deleted when version “1.2” is upgraded to version “1.3”, for example, as the suspected code block. For example, the processing unit 12 compares the code blocks in units of commit included in the sets of source code 33 and 34 and identifies a code block that is included in the set of source code 33 but not included in the set of source code 34.

The set of source code 33 includes code blocks A, D, and E. The set of source code 34 includes code blocks A, D1, and E. In this case, a code block that is included in the set of source code 33 but not included in the set of source code 34 is the code block D. Thus, the processing unit 12 identifies the code block D as the code block that is deleted when version “1.2” is upgraded to version “1.3”, for example as the suspected code block.

The processing unit 12 detects a version including the identified code block out of the plurality of versions. The version including the identified code block may be said to be a version corresponding to the set of source code including the identified code block.

For example, the set of source code 31 includes the code blocks A, B, and C. The set of source code 32 includes the code blocks A, D, and C. The set of source code 35 includes the code blocks A, G, and C. The set of source code 36 includes the code blocks H, D, and I. In this case, the processing unit 12 detects versions “1.1”, “1.2”, and “3.0” including the suspected code block D out of the sets of source code 31 to 36 of software versions “1.0”, “1.1”, “1.2”, “1.3”, “2.0”, and “3.0”.

The processing unit 12 outputs information indicative of the detected version. For example, the processing unit 12 may cause a display device coupled to the information processing apparatus 10 to display the information indicative of the detected version or may transmit the information indicative of the detected version to another information processing apparatus via a network. For example, the processing unit 12 may present to the user that the version may include vulnerability by causing the display device to display the graph of the tree structure representative of the above-described order relationships between the versions described above and to highlight a node corresponding to a version including a suspected code block.

With the information processing apparatus 10, the update history information 20 including the update history of each of the plurality of versions of software is obtained. A second version corresponding to an update history including a predetermined keyword is identified from the update history information 20. Based on the development history information 30 including a change location in the source code of the software between the identified second version and a first version immediately previous to the second version, a code block deleted from the source code when the first version is upgraded to the second version is identified as a code block that may include vulnerability. A version including the identified code block in the source code is detected out of the plurality of versions.

Thus, the information processing apparatus 10 may efficiently determine the version including vulnerability. In many cases, for example, publicized information such as the update history information 20 does not describe in detail specific update contents such as fixed locations of the software in question. For this reason, even when it is understood that a certain type of vulnerability has been responded in a certain version, it is difficult to check whether a version other than the certain version includes the certain type of vulnerability.

For example, it is conceivable that the information processing apparatus 10 performs reproduction testing on all the versions of the software for the checking. For example, in the reproduction testing, the information processing apparatus 10 operates the software and reproduces an attack in a pseudo manner to check whether vulnerability exits. Accordingly, the reproduction testing for all the versions is costly. For example, workload of the user for setting up the environment of the reproduction testing for all the versions becomes excessive, or the reproduction testing with the information processing apparatus 10 takes time.

Accordingly, the information processing apparatus 10 may efficiently detect a version that may include vulnerability by identifying a code block that may include a vulnerability based on the update history information 20 and the development history information 30 and by detecting a version that includes the code block. For example, the information processing apparatus 10 may improve accuracy of the work, performed by the user, of checking the presence/absence of vulnerability of the software and may enable checking of the influence at a source code level. Since not all the versions are subjected to the reproduction testing with the information processing apparatus 10, the workload of the user for checking vulnerability may be decreased. The information processing apparatus 10 may assist in determining a version including vulnerability more quickly than in the case where the reproduction testing is performed on all the versions.

Hereinafter, the functions of the information processing apparatuses 10 will be described more specifically.

### Second Embodiment

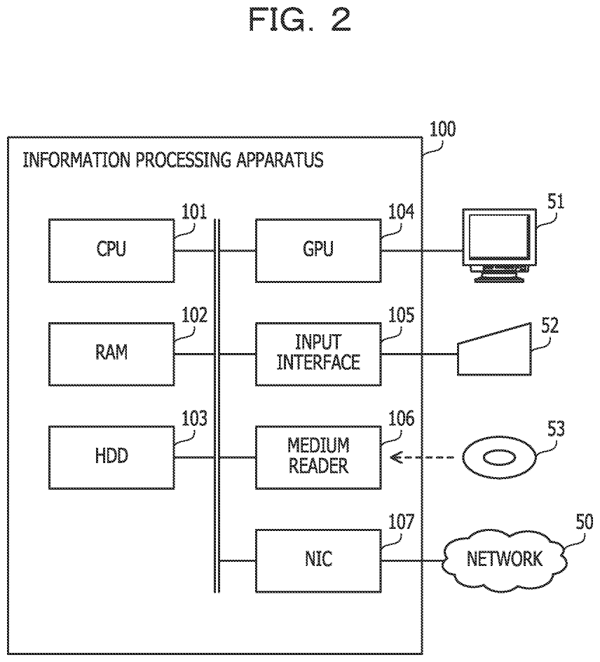

FIG. 2 is a diagram illustrating an example of hardware of an information processing apparatus according to a second embodiment. An information processing apparatus 100 assists in checking vulnerability in OSS in the case where a subset of the functions of a certain software product are realized by using the OSS in software development. The information processing apparatus 100 may be realized by using a server computer.

The information processing apparatus 100 includes a CPU 101, a RAM 102, an HDD 103, a graphics processing unit (GPU) 104, an input interface 105, a medium reader 106, and a network interface card (NIC) 107. The CPU 101 corresponds to the processing unit 12 according to the first embodiment. The RAM 102 or the HDD 103 corresponds to the storage unit 11 according to the first embodiment.

The CPU 101 is a processor that executes instructions of a program. The CPU 101 loads at least part of a program or data stored in the HDD 103 into the RAM 102 and executes the program. The CPU 101 may include a plurality of processor cores. The information processing apparatus 100 may include a plurality of processors. Processing described below may be executed in parallel by using the plurality of processors or processor cores. A set of the plurality of processors may be referred to as a “multiprocessor” or merely referred to as a “processor” in some cases.

The RAM 102 is a volatile semiconductor memory that temporarily stores the program executed by the CPU 101 or data used for operation performed by the CPU 101. The information processing apparatus 100 may include a memory of a type other than the RAM and may include a plurality of memories.

The HDD 103 is a non-volatile storage device that stores data as well as programs of software such as an operating system (OS), middleware, and application software. The information processing apparatus 100 may include a storage device of the other type such as a flash memory or a solid-state drive (SSD) or may include a plurality of non-volatile storage devices.

The GPU 104 outputs an image to a display 51 coupled to the information processing apparatus 100 in accordance with an instruction from the CPU 101. An arbitrary type of a display such as a cathode ray tube (CRT) display, a liquid crystal display (LCD), a plasma display, or an organic electro-luminescence (OEL) display may be used as the display 51.

The input interface 105 obtains an input signal from an input device 52 coupled to the information processing apparatus 100 and outputs the input signal to the CPU 101. As the input device 52, a pointing device such as a mouse, a touch panel, a touchpad, or a trackball, a keyboard, a remote controller, a button switch, or the like may be used. A plurality of types of input devices may be coupled to the information processing apparatus 100.

The medium reader 106 is a reading device that reads a program or data recorded in a recording medium 53. As the recording medium 53, for example, a magnetic disk, an optical disc, a magneto-optical (MO) disk, a semiconductor memory, or the like may be used. Examples of the magnetic disk include a flexible disk (FD) and an HDD. Examples of the optical disc include a compact disc (CD) and a Digital Versatile Disc (DVD).

For example, the medium reader 106 copies the program or the data read from the recording medium 53 into another recording medium such as the RAM 102 or the HDD 103. The read program is executed by, for example, the CPU 101. The recording medium 53 may be a portable-type recording medium and used to distribute the program and the data. The recording medium 53 and the HDD 103 may be referred to as computer-readable recording media in some cases.

The NIC 107 is coupled to a network 50 and is an interface that communicates with another computer via the network 50. The NIC 107 is coupled to, for example, a communication device such as a switch or a router via a cable. The NIC 107 may be a wireless communication interface.

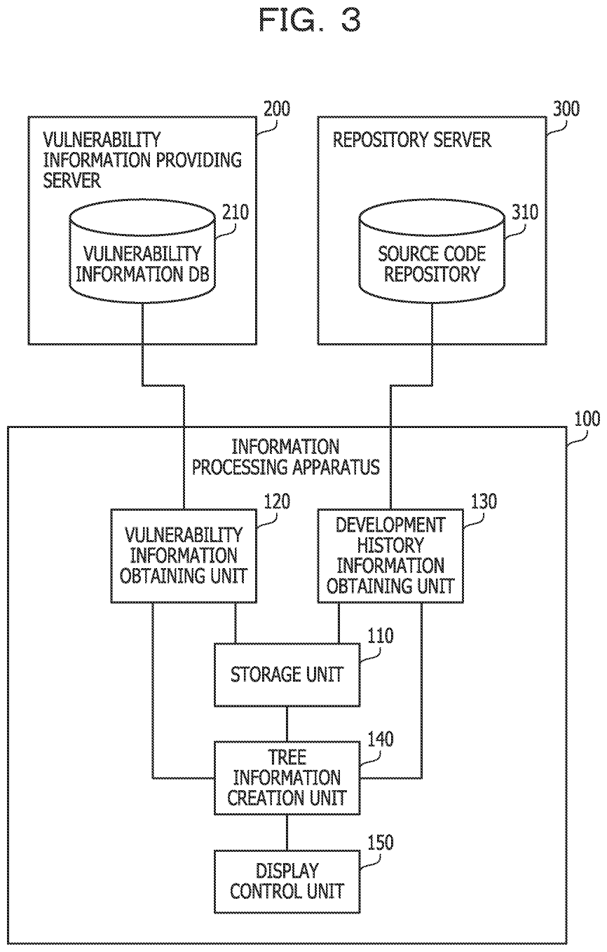

FIG. 3 is a diagram illustrating an example of the functions of the information processing apparatus. The information processing apparatus 100 includes a storage unit 110, a vulnerability information obtaining unit 120, a development history information obtaining unit 130, a tree information creation unit 140, and a display control unit 150. A storage area of the RAM 102 or the HDD 103 is used for the storage unit 110. The vulnerability information obtaining unit 120, the development history information obtaining unit 130, the tree information creation unit 140, and the display control unit 150 are realized by executing, by using the CPU 101, a program stored in the RAM 102.

The storage unit 110 stores vulnerability information of the OSS obtained by using the vulnerability information obtaining unit 120. The vulnerability information is, for example, information publicized by using a vulnerability information providing server 200 operated by a predetermined organization. The vulnerability information providing server 200 includes a vulnerability information database (DB) 210 that controls the vulnerability information. Examples of the Uniform Resource Locator (URL) of the vulnerability information providing server 200 include, for example, “https://nvd.nist.gov/vuln/search”.

The storage unit 110 stores update history information of the OSS, development history information of the OSS, and source code of each version of the OSS which have been obtained by the development history information obtaining unit 130. The update history information, the development history information, and the sets of source code are, for example, information publicized by using a repository server 300 operated by a predetermined organization. The repository server 300 includes a source code repository 310 that controls the update history information, the development history information, and the source code for various types of software.

The update history information is a history of updates, in units of commit, of the source code of the OSS and includes comments on a status of functional addition and a remediation status of vulnerability in each of commits. The development history information includes the order relationship between the versions of the OSS (for example, a tag or a timestamp indicative of the order relationship in the source code repository 310) and information on an update location of the source code in each of the commit. Examples of the URL of the Web server that publicizes the update history information, the development history information, and the source code include, for example, “https://github.com”. GITHUB is a registered trademark.

When OSS which is the checking target for vulnerability is designated by the user, the vulnerability information obtaining unit 120 obtains the vulnerability information of the checking target OSS from the vulnerability information DB 210 via the network 50. The vulnerability information obtaining unit 120 stores the obtained vulnerability information in the storage unit 110.

When the OSS which is the checking target for vulnerability is designated by the user, the development history information obtaining unit 130 obtains update history information and development history information of the OSS and source code of each version of the OSS from the source code repository 310 via the network 50. The development history information obtaining unit 130 stores the obtained update history information, development history information, and the source code in the storage unit 110.

Based on the development history information stored in the storage unit 110, the tree information creation unit 140 creates information on a version tree representative of the order relationships between the versions of the OSS. Based on the update history information, the development history information, and the source code of each version, the tree information creation unit 140 adds information indicative of a version that may include a vulnerability to the tree information. The tree information creation unit 140 outputs the information on the created version tree to the display control unit 150.

The display control unit 150 causes the display 51 to display a graphical user interface (GUI) for checking vulnerability of the OSS and accepts operation of the user for checking the vulnerability. Upon accepting the designation of the OSS which is the checking target for vulnerability in accordance with the operation on the GUI by the user, the display control unit 150 notifies the vulnerability information obtaining unit 120 and the development history information obtaining unit 130 of the designated OSS. Also, the display control unit 150 causes the display 51 to display the version tree created by the tree information creation unit 140 with respect to the designated OSS. The display control unit 150 may transmit information on the GUI including the version tree to another information processing apparatus via the network 50 and accept a user operation for checking the vulnerability from the other information processing apparatus.

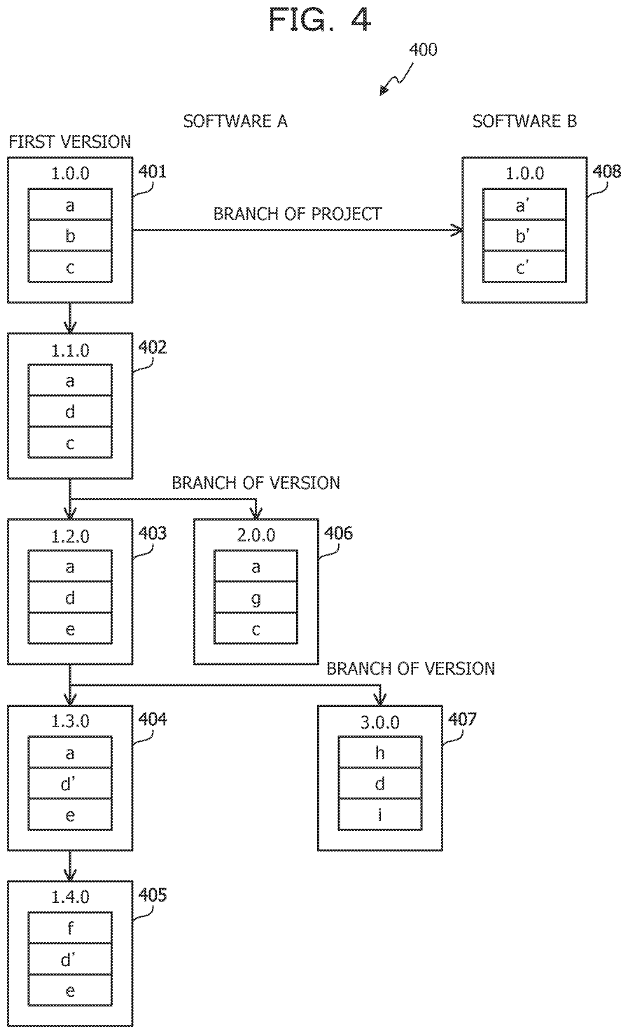

FIG. 4 is a diagram illustrating an example of the version tree. A version tree 400 represents the order relationships between the versions related to OSS named “software A”. The version tree 400 is represented by a graph including nodes that represent the versions or the sets of source code corresponding to the versions and edges that are arrows representative of the order relationships between the versions. For example, the version tree 400 includes nodes 401, 402, 403, 404, 405, 406, 407, and 408. A direction extending from the top to bottom of the version tree 400 is a direction of upgrade.

The node 401 indicates version “1.0.0”. Version “1.0.0” is the first version. The node 402 indicates version “1.1.0”. Version “1.1.0” is the next version to version “1.0.0”. The node 403 indicates version “1.2.0”. Version “1.2.0” is the next version to version “1.1.0”. The node 404 indicates version “1.3.0”. Version “1.3.0” is the next version to version “1.2.0”. The node 405 indicates version “1.4.0”. Version “1.4.0” is the next version to version “1.3.0”.

The node 406 indicates version “2.0.0”. Version “2.0.0” is the next version to version “1.1.0”. Version “2.0.0” is a version that branches from upgrading from version “1.1.0” to version “1.2.0”. The node 407 indicates version “3.0.0”. Version “3.0.0” is the next version to version “1.2.0”. Version “3.0.0” is a version that branches from upgrading from version “1.2.0” to version “1.3.0”. The node 408 indicates version “1.0.0” of software B of another project that branches from a project of the software A.

A set of source code of each of the versions includes a plurality of code blocks identified in units of commit when registered in the source code repository 310. For example, the set of source code of version “1.0.0” of the software A includes code blocks a, b, and c. The set of source code of version “1.1.0” includes the code blocks a, d, and c. The set of source code of version “1.2.0” includes the code blocks a, d, and e. The set of source code of version “1.3.0” includes the code blocks a, d′, and e. The set of source code of version “1.4.0” includes the code blocks f, d′, and e. The set of source code of version “2.0.0” includes the code blocks a, g, and c. The set of source code of version “3.0.0” includes the code blocks h, d, and i. The set of source code of version “1.0.0” of the software B includes the code blocks a′, b′, and c′.

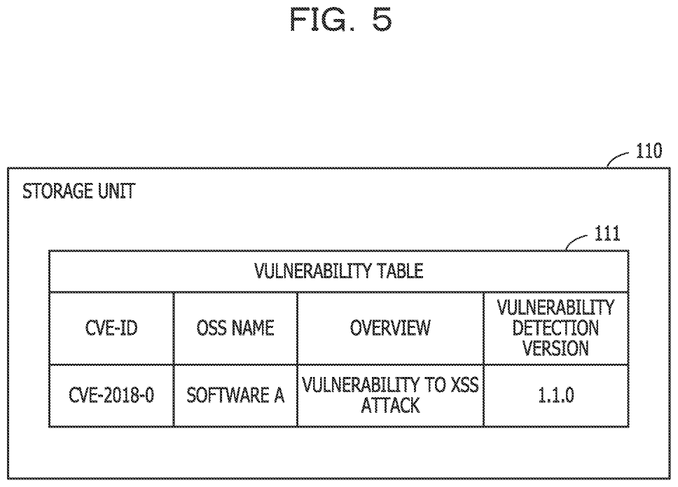

FIG. 5 is a diagram illustrating an example of a vulnerability table. A vulnerability table 111 is created based on vulnerability information on the software A that is obtained from the vulnerability information DB 210 by the vulnerability information obtaining unit 120. The vulnerability table 111 is stored in the storage unit 110. The vulnerability table 111 includes items of the CVE-ID, an OSS name, an overview, and a vulnerability detection version.

A CVE-ID is registered in the item of the CVE-ID. The CVE-ID is ordinarily publicized as an identifier that identifies vulnerability found with respect to the software in question. The CVE-ID may also be simply referred to as a CVE. The name of OSS is registered in the item of the OSS name. An overview of the vulnerability is registered in the item of the overview. A version in which the vulnerability is detected is registered in the item of the vulnerability detection version.

For example, in the vulnerability table 111, a record including the CVE-ID of “CVE-2018-0”, the OSS name of “SOFTWARE A”, the overview of “VULNERABILITY TO CROSS SITE SCRIPTING (XSS) ATTACK”, and the vulnerability detection version of “1.1.0” is registered. This record indicates that the vulnerability to the XSS attack is checked in version “1.1.0” of the OSS of the OSS name “SOFTWARE A” and the CVE-ID of the vulnerability is “CVE-2018-0”. For example, a date on which the vulnerability is checked (information update date) may be registered in individual records of the vulnerability table 111.

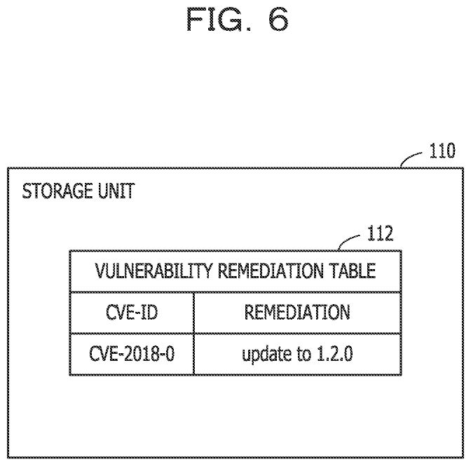

FIG. 6 is a diagram illustrating an example of a vulnerability remediation table. A vulnerability remediation table 112 is created based on vulnerability remediation information obtained from the vulnerability information DB 210 or another information processing apparatus by the vulnerability information obtaining unit 120 and stored in the storage unit 110. Examples of the URL of a Web server that publicizes vulnerability remediation information include, for example, “https://jvndb.jvn.jp”. The vulnerability remediation table 112 includes items of the CVE-ID and the remediation. A CVE-ID is registered in the item of the CVE-ID. The content of remediation of the CVE-ID is registered in the item of the remediation.

For example, a record including the CVE-ID of “CVE-2018-0” and the remediation of “update to 1.2.0” is registered in the vulnerability remediation table 112. This record indicates that the CVE-ID “CVE-2018-0” has been remediated in version “1.2.0”.

Although the vulnerability remediation information indicates that the remediation has been made in the version “1.2.0”, it is unclear that in which of commits in version “1.2.0” the vulnerability has been remediated. For this reason, there is a possibility that the vulnerability remains in an older commit in version “1.2.0”. Thus, it may be difficult to understand that the vulnerability is reliably remediated in this version only from the content of the remediation in the vulnerability remediation table 112. Accordingly, in the information processing apparatus 100, the information of the item of remediation in the vulnerability remediation table 112 is merely used as reference information. As will be described later, the information processing apparatus 100 obtains the update history information and the development history information on the software A from the source code repository 310 and checks in detail the remediation status of the vulnerability in units of commit.

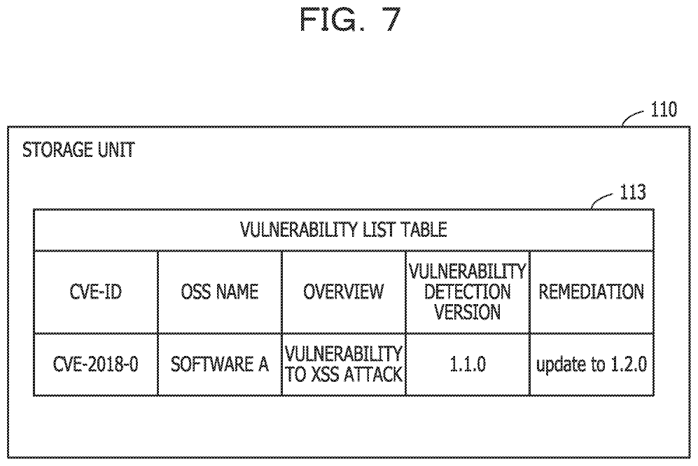

FIG. 7 is a diagram illustrating an example of a vulnerability list table. A vulnerability list table 113 is created by the vulnerability information obtaining unit 120 based on the vulnerability table 111 and the vulnerability remediation table 112. The vulnerability list table 113 is stored in the storage unit 110. The vulnerability list table 113 is a table formed by combining the vulnerability table 111 and the vulnerability remediation table 112 by using the CVE-ID as a key. The vulnerability list table 113 includes the items of the CVE-ID, the OSS name, the overview, the vulnerability detection version, and the remediation. The contents registered in these items are the same as those of the items having the same names in the vulnerability table 111 and the vulnerability remediation table 112.

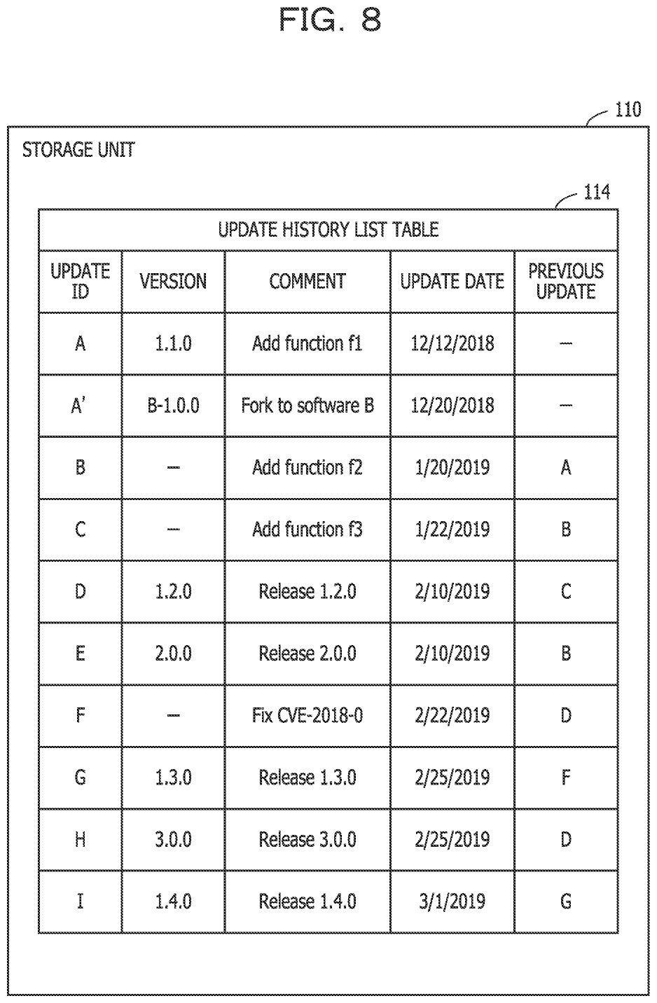

FIG. 8 is a diagram illustrating an example of an update history list table. An update history list table 114 is created by the development history information obtaining unit 130 based on the update history information and the development history information on the software A which have been obtained from the source code repository 310. The update history list table 114 is stored in the storage unit 110. The contents of the update history information and the development history information are reflected in the update history list table 114. The update history list table 114 includes items of an update ID, the version, a comment, an update date, and a previous update.

An update ID that identifies an update of the source code of the OSS is registered in the item of the update ID. A version of the OSS is registered in the item of the version. Text describing the update contents is registered in the item of the comment. A date on which the update is performed, for example, an update date is registered in the item of the update date. An update ID corresponding to a version immediately previous to this version is registered in the item of the previous update.

For example, in the update history list table 114, a record including the update ID of “A”, the version of “1.1.0”, the comment of “Add function f1”, the update date of “2018/12/12”, and the previous update of “-” (no setting) is registered. This record indicates that, in version “1.1.0” of the software A corresponding to the update identified by the update ID “A”, the function f1 was added and the date on which this update was performed is Dec. 12, 2018. Since version “1.1.0” is the update performed on the first version “1.0.0”, there is no setting of the previous update.

A record related to a history of another update is also registered in the update history list table 114. A record of the update ID of “A′” in the update history list table 114 is a history related to the software B. Version “B-1.0.0” of the record of the update ID of “A′” indicates version “1.0.0” of the software B.

A record having the version of “-” (no setting) is also included in the update history list table 114. A record having the version of “-” is not an update corresponding to a formally released version but a record related to a commit performed before a release of a new version.

For example, in the update history list table 114, a record including the update ID of “B”, the version of “-”, the comment of “Add function f2”, the update date of “2019/1/20”, and the previous update of “A” is registered.

In the update history list table 114, a record including the update ID of “F”, the version of “-”, the comment of “Fix CVE-2018-0”, the update date of “2019/2/22”, and the previous update of “D” is registered. The comment of “Fix CVE-2018-0” means that vulnerability identified by the CVE-ID of “CVE-2018-0” has been remediated.

The tree information creation unit 140 may create the information of the version tree 400 by tracking the update ID registered in the previous update which is included in each record of the update history list table 114.

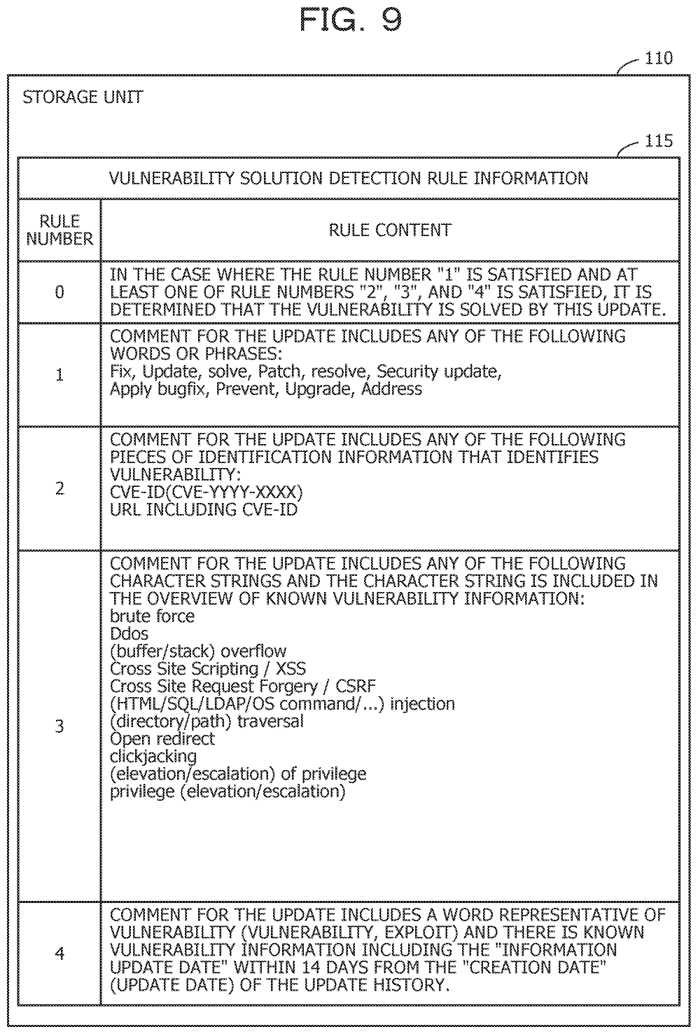

FIG. 9 is a diagram illustrating an example of vulnerability solution detection rule information. Vulnerability solution detection rule information 115 is stored in the storage unit 110 in advance. The vulnerability solution detection rule information 115 indicates rules for determining whether the individual records in the update history list table 114 correspond to an update in which a vulnerability is solved. Depending on whether the comment included in each record of the update history list table 114 satisfies the rule registered in the vulnerability solution detection rule information 115, the tree information creation unit 140 determines whether the record corresponds to the update in which the vulnerability is solved. The vulnerability solution detection rule information 115 includes items of a rule number and a rule content. The rule number that is a number identifying a rule is registered in the item of the rule number. The rule content is registered in the item of the rule content.

For example, in the vulnerability solution detection rule information 115, as the rule content of the rule number “0”, “IN THE CASE WHERE THE RULE NUMBER “1” IS SATISFIED AND AT LEAST ONE OF RULE NUMBERS “2”, “3”, AND “4” IS SATISFIED, IT IS DETERMINED THAT THE VULNERABILITY IS SOLVED BY THIS UPDATE” is registered. Rule contents of the rule numbers “1” to “4” are also registered in the vulnerability solution detection rule information 115.

The rule content of the rule number “1” is that the comment for the update includes any of the following words or phrases. For example, the words or phrases include Fix, Update, solve, Patch, resolve, Security update, Apply bugfix, Prevent, Upgrade, Address, and conjugated forms of these.

The rule content of the rule number “2” is that the comment for the update includes any of the following pieces of identification information that identifies vulnerability. For example, the pieces of identification information are a CVE-ID and a URL including the CVE-ID. For example, the CVE-ID is represented in the form of CVE-YYYY-XXXX. Here, “YYYY” and “XXXX” represent arbitrary string numerics.

The rule content of the rule number “3” is that the comment for the update includes any of the following character strings and the character string is included in the overview of known vulnerability information. The overview of the known vulnerability information corresponds to the content of the item of the overview in the vulnerability table 111 or the vulnerability list table 113 for the software. Examples of the character strings include, for example, brute force, Ddos, (buffer/stack) overflow, Cross Site Scripting/XSS, Cross Site Request Forgery/CSRF, . . . , and so forth and conjugated forms of these.

For example, in FIG. 9, a description such as “(buffer/stack) overflow” represents that a character string in which any one of words separated by a slash symbol within parentheses and a word after the parentheses are coupled is set as a character string to be detected. For example, a description such as “Cross Site Scripting/XSS” represents that a character string after a slash symbol is an abbreviation of a character string before the slash symbol, and one of the character strings before and after the slash symbol is set as a character string to be detected.

The rule content of the rule number “4” is that the comment for the update includes a word representative of vulnerability (vulnerability, exploit) and there is known vulnerability information including the “information update date” within 14 days from the “creation date” (update date) of the update history. The word representative of vulnerability may be a conjugated form of vulnerability or exploit.

Since the comment of the record of the update ID “F” in the update history list table 114 includes “Fix”, the rule of the rule number “1” in the vulnerability solution detection rule information 115 is satisfied. Also, since the comment of the record of the update ID “F” in the update history list table 114 includes “CVE-2018-0” in the form of “CVE-YYYY-XXXX”, the rule of the rule number “2” in the vulnerability solution detection rule information 115 is satisfied. Thus, based on the rule of the rule number “0”, the tree information creation unit 140 detects that the vulnerability of “CVE-2018-0” has been solved by the update corresponding to the record of the update ID “F”.

The words, character strings, and so force to be detected that are described as examples in the vulnerability solution detection rule information 115 are merely exemplary and words or character strings other than the exemplary words or character strings may be set as a detection target for solving vulnerability.

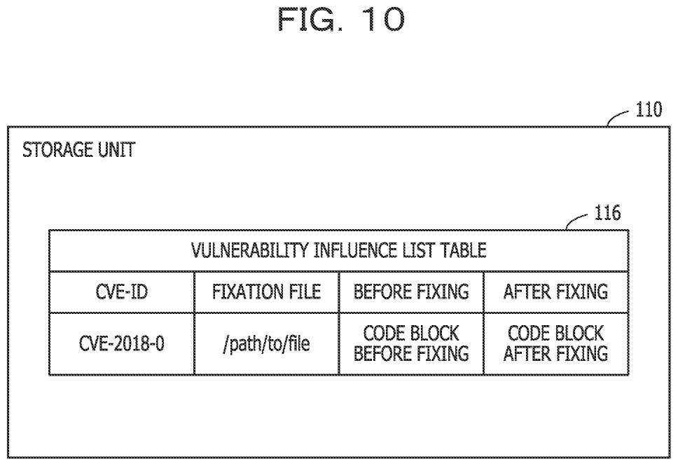

FIG. 10 is a diagram illustrating an example of a vulnerability influence list table. A vulnerability influence list table 116 is generated by the tree information creation unit 140 based on the update history list table 114 and the source code of each version of the OSS and stored in the storage unit 110. The vulnerability influence list table 116 includes items of the CVE-ID, a fixation file, a before fixing, and an after fixing. A CVE-ID is registered in the item of the CVE-ID. A path to a file of the source code including the fixed content is registered in the item of the fixation file. Information indicative of a code block before the fixing is registered in the item of the before fixing. Information indicative of a code block after the fixing is registered in the item of the after fixing.

For example, in the vulnerability influence list table 116, a record including the CVE-ID of “CVE-2018-0”, the fixation file of “/path/to/file”, the before fixing of “CODE BLOCK BEFORE FIXING”, and the after fixing of “CODE BLOCK AFTER FIXING” is registered. This record indicates that the fixation file for the vulnerability identified by the CVE-ID of “CVE-2018-0” is “/path/to/file”. Also, the record indicates that a location before the fixing in the fixation file corresponds to description represented by “CODE BLOCK BEFORE FIXING” and a location after the fixing corresponds to description represented by a “CODE BLOCK AFTER FIXING”. Here, “CODE BLOCK BEFORE FIXING” in the item of the before fixing and “CODE BLOCK AFTER FIXING” in the item of the after fixing may be description itself of the code blocks or positional information such as line numbers corresponding to the code blocks in the fixation file.

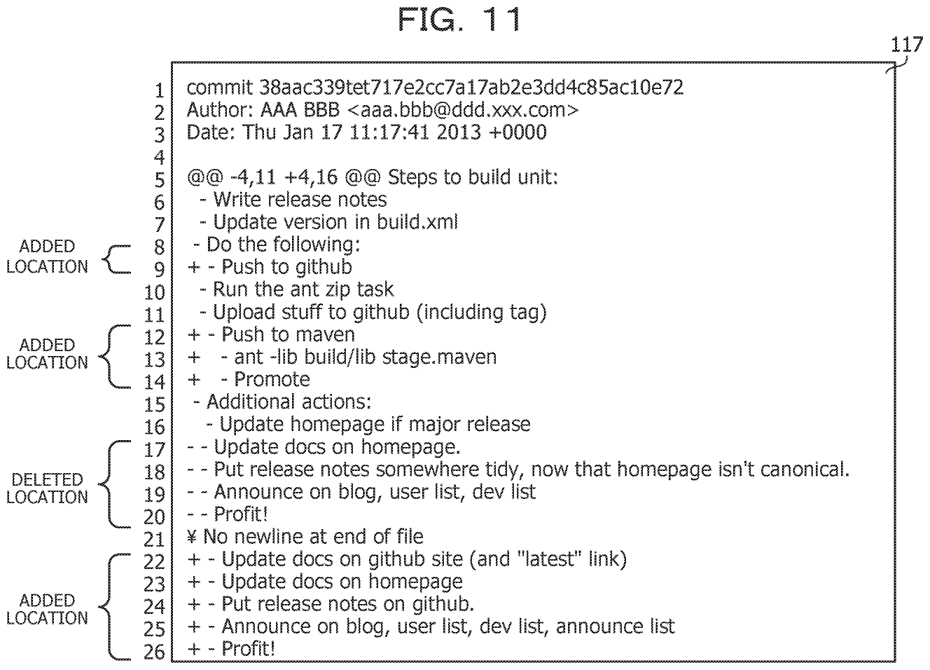

FIG. 11 is a diagram illustrating an example of a fixation file. A fixation file 117 is generated by the tree information creation unit 140 based the update history list table 114 and comparison in source code between a version after the vulnerability of the OSS has been solved and a version immediately before the version after the vulnerability of the OSS has been solved. The fixation file 117 is stored in the storage unit 110. The fixation file 117 represents an example in which information is obtained by using Git, which is a source code control tool. According to the example of the update history list table 114, the version after the vulnerability of the OSS has been solved is version “1.3.0”. The version immediately before the version after the vulnerability of the OSS has been solved is version “1.2.0”. The fixation file 117 corresponds to the fixation file “/path/to/file” in the vulnerability influence list table 116.

For example, lines 17 to 20 of the fixation file 117 is a deleted location when the vulnerability identified by the CVE-ID of “CVE-2018-0” is solved, for example, a deleted code block. The deleted code block is a suspected code block that is likely to be a cause of vulnerability. The suspected code block corresponding to lines 17 to 20 of the fixation file 117 corresponds to the “CODE BLOCK BEFORE FIXING” in the vulnerability influence list table 116.

Lines 9, 12 to 14, and 22 to 26 of the fixation file 117 are added locations when the vulnerability identified by the CVE-ID of “CVE-2018-0” is solved, for example, added code blocks. The added code blocks corresponding to lines 9, 12 to 14, and 22 to 26 of the fixation file 117 correspond to the “CODE BLOCK BEFORE FIXING” in the vulnerability influence list table 116.

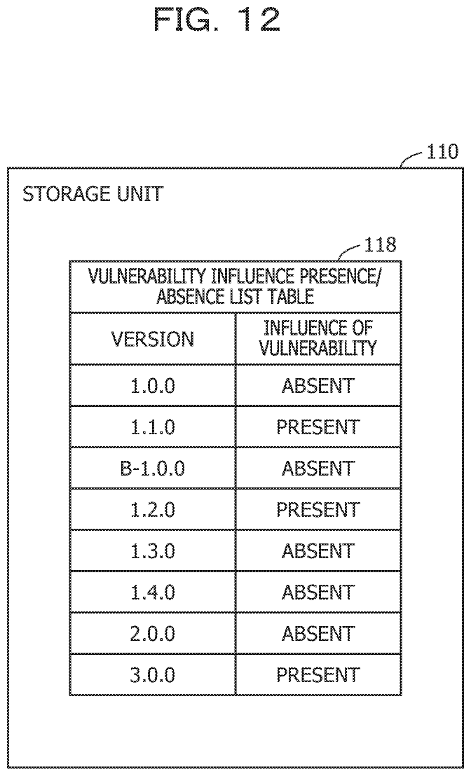

FIG. 12 is a diagram illustrating an example of a vulnerability influence presence/absence list table. A vulnerability influence presence/absence list table 118 is generated by the tree information creation unit 140 and stored in the storage unit 110. Out of the sets of source code of the individual versions of the OSS, the tree information creation unit 140 identifies a version corresponding to a set of source code including the suspected code block. The tree information creation unit 140 registers, as a version in which the influence of vulnerability exists, the identified version in the vulnerability influence presence/absence list table 118.

The vulnerability influence presence/absence list table 118 includes items of the version and the influence of vulnerability. A version of the OSS is registered in the item of the version. A result of determination of the presence/absence of the influence of the vulnerability performed by the tree information creation unit 140 is registered in the item of the influence of vulnerability.

For example, a record including the version of “1.0.0” and the influence of vulnerability of “ABSENT” is registered in the vulnerability influence presence/absence list table 118. This record indicates that the set of source code of version “1.0.0” of the software A does not include a suspected code block and is not under the influence of the vulnerability due to the suspected code block.

A record including the version of “1.1.0” and the influence of vulnerability of “PRESENT” is registered in the vulnerability influence presence/absence list table 118. This record indicates that the set of source code of version “1.1.0” of the software A includes a suspected code block and is under the influence of the vulnerability due to the suspected code block.

Records indicative of results of determination on the influence of vulnerability related to the other versions of the software A and version “1.0.0” of the software B are also registered in the vulnerability influence presence/absence list table 118.

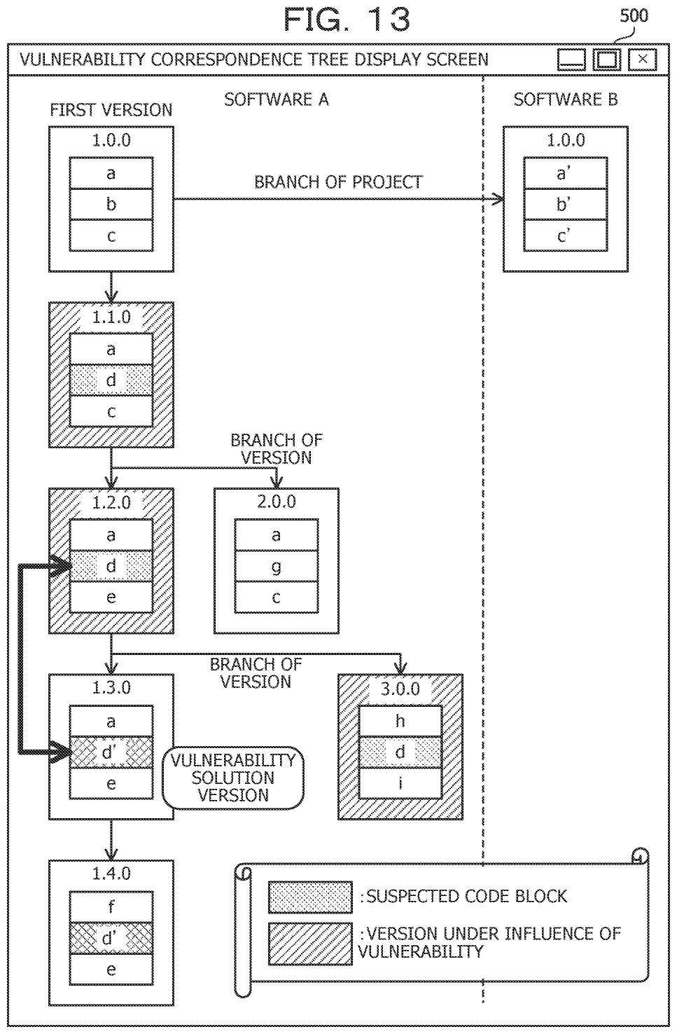

FIG. 13 is a diagram illustrating an example of a vulnerability correspondence tree display screen. Based on the vulnerability influence presence/absence list table 118, the tree information creation unit 140 displays a vulnerability correspondence tree display screen 500 on the display 51. The tree information creation unit 140 may transmit screen information of the vulnerability correspondence tree display screen 500 to another information processing apparatus via the network 50 or may cause a display device coupled to the other information processing apparatus to display the vulnerability correspondence tree display screen 500.

The vulnerability correspondence tree display screen 500 includes an image representative of the version tree 400 illustrated as the example in FIG. 4. The tree information creation unit 140 highlights a version that may include vulnerability in the image representative of the version tree 400.

In the example of the software A described above, the tree information creation unit 140 detects that the software A has the vulnerability of the CVE-ID of “CVE-2018-0” based on the vulnerability table 111 or the vulnerability list table 113.

Based on the update history list table 114, the tree information creation unit 140 detects that the vulnerability of the CVE-ID of “CVE-2018-0” has been solved in version “1.3.0”. Based on the update history list table 114, the tree information creation unit 140 identifies version “1.2.0” which is a version immediately before version “1.3.0”.

The tree information creation unit 140 compares the two versions in source code and detects that the code block d is deleted from the source code and the code block d′ is added to the source code between version “1.2.0” and version “1.3.0”. At this time, the tree information creation unit 140 uses a set of source code at the time of the update ID of “D” in the update history list table 114 as the set of source code of version “1.2.0”. The code block d is a suspected code block corresponding to lines 17 to 20 of the fixation file 117 illustrated in FIG. 11. The tree information creation unit 140 may identify the suspected code block d by comparing the set of source code at the time of the update ID of “D” and the set of source code at the time of the update ID of “F” in the update history list table 114.

The tree information creation unit 140 detects a set of source code including the suspected code block d out of the sets of source code of the individual versions of the software A and the software B created by branching the software A. The tree information creation unit 140 determines the version corresponding to the set of source code including the suspected code block d as a version under the influence of the vulnerability.

In the example of the software A and the software B, the sets of source code of versions “1.1.0”, “1.2.0”, and “3.0.0” of the software A includes the suspected code block d. Accordingly, the tree information creation unit 140 causes the nodes of versions “1.1.0”, “1.2.0”, and “3.0.0” to be highlighted in the image of the version tree 400 on the vulnerability correspondence tree display screen 500. At this time, the tree information creation unit 140 may display the code blocks included in the sets of source code of individual versions so as to be identifiable in the nodes and may highlight an image such as an icon or a character string representative of the suspected code block d.

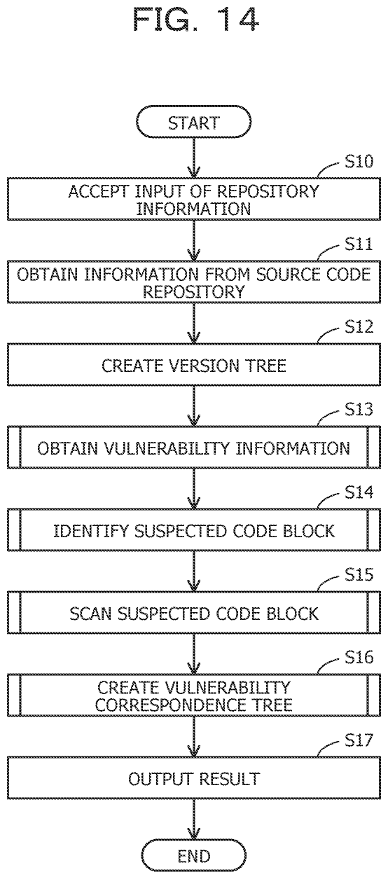

Next, a processing procedure of the information processing apparatus 100 will be described. FIG. 14 is a flowchart illustrating an example of processing of the information processing apparatus.

(S10) The development history information obtaining unit 130 accepts input of repository information indicative of the name of OSS which is the checking target for vulnerability and the repository server 300 or the source code repository 310 which is an access destination. For example, the user may input the repository information to the information processing apparatus 100 by operating the GUI displayed, by the display control unit 150, on the display 51.

(S11) Based on the input repository information, the development history information obtaining unit 130 obtains, from the source code repository 310, the update history information and the development history information of the OSS and the source code of each version and stores the obtained information and the source code in the storage unit 110.

(S12) Based on the development history information stored in the storage unit 110, the tree information creation unit 140 creates information on the version tree 400.

(S13) The vulnerability information obtaining unit 120 performs a vulnerability information obtaining process. In the vulnerability information obtaining process, the vulnerability information obtaining unit 120 obtains the vulnerability information related to the target OSS from the vulnerability information DB 210 and generates the vulnerability list table 113 based on the obtained vulnerability information. The details of the vulnerability information obtaining process will be described later.

(S14) The tree information creation unit 140 performs a suspected code block identification process. In the suspected code block identification process, the tree information creation unit 140 identifies the suspected code block and generates the vulnerability influence list table 116 indicative of information on the identified suspected code block. The details of the suspected code block identification process will be described later.

(S15) The tree information creation unit 140 performs a suspected code block scanning process. In the suspected code block scanning process, the tree information creation unit 140 detects a set of source code including the suspected code block identified in operation S14 out of the sets of source code of the versions of the target OSS. The details of the suspected code block scanning process will be described later.

(S16) The tree information creation unit 140 performs a vulnerability correspondence tree creation process. In the vulnerability correspondence tree creation process, the tree information creation unit 140 adds information indicative of the version including the suspected code block to information of the version tree 400. The details of the vulnerability correspondence tree creation process will be described later.

(S17) The display control unit 150 outputs a result of the vulnerability correspondence tree creation process performed by the tree information creation unit 140. For example, the display control unit 150 causes the display 51 to display the vulnerability correspondence tree display screen 500. The display control unit 150 may transmit information of the vulnerability correspondence tree display screen 500 to another information processing apparatus or may cause a display coupled to the other information processing apparatus to display the vulnerability correspondence tree display screen 500. The processing of the information processing apparatus 100 ends.

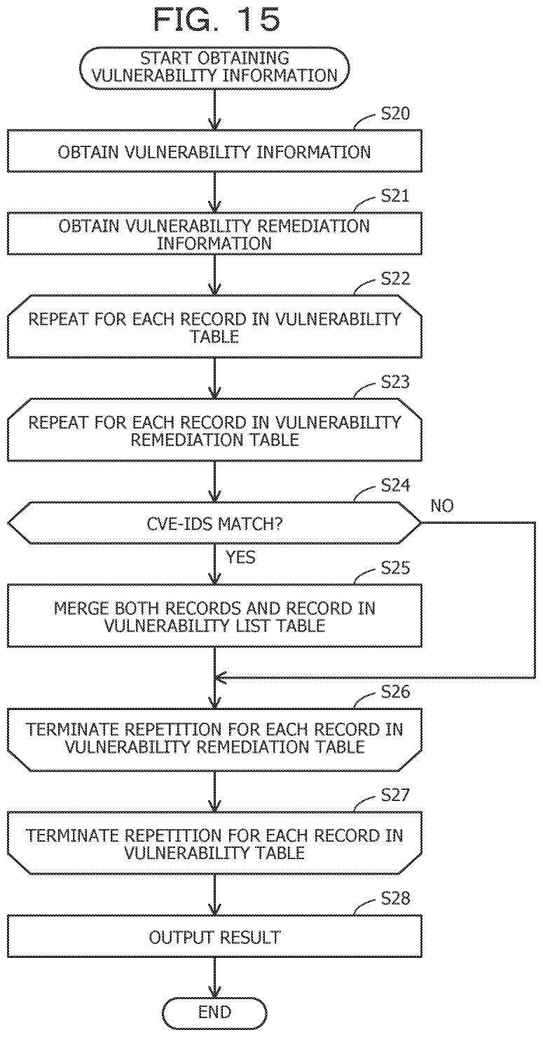

FIG. 15 is a flowchart illustrating an example of the vulnerability information obtaining process. The vulnerability information obtaining process corresponds to operation S13.

(S20) The vulnerability information obtaining unit 120 obtains, from the vulnerability information DB 210, the vulnerability information related to the target OSS designated in the repository information and generates the vulnerability table 111 based on the vulnerability information. The vulnerability information obtaining unit 120 stores the vulnerability table 111 in the storage unit 110.

(S21) The vulnerability information obtaining unit 120 obtains the vulnerability remediation information from the Web server that publicizes the vulnerability remediation information, and the vulnerability information obtaining unit 120 generates the vulnerability remediation table 112 based on the vulnerability remediation information. The vulnerability information obtaining unit 120 stores the vulnerability remediation table 112 in the storage unit 110.

(S22) For each record in the vulnerability table 111, the vulnerability information obtaining unit 120 repeatedly executes operations S23 to S26.

(S23) For each record in the vulnerability remediation table 112, the vulnerability information obtaining unit 120 repeatedly executes operations S24 and S25. However, for a certain record, operation S25 may be skipped depending on determination in operation S24.

(S24) The vulnerability information obtaining unit 120 determines whether the CVE-ID of the record in the vulnerability table 111 matches to the CVE-ID of the record in the vulnerability remediation table 112. In the case where they match to each other, the processing proceeds to operation S25. In the case where they do not match to each other, the processing proceeds to operation S26.

(S25) The vulnerability information obtaining unit 120 merges both the records determined to have the same CVE-ID in operation S24 to record in the vulnerability list table 113.

(S26) Upon completion of the repeated execution for all the records in the vulnerability remediation table 112, the vulnerability information obtaining unit 120 causes the processing to proceed to operation S27.

(S27) Upon completion of the repeated execution for all the records in the vulnerability table 111, the vulnerability information obtaining unit 120 causes the processing to proceed to operation S28.

(S28) The vulnerability information obtaining unit 120 outputs a result. For example, the vulnerability information obtaining unit 120 saves to the storage unit 110 the vulnerability list table 113 generated as the result of the processing of operations S20 to S27. The vulnerability information obtaining process ends.

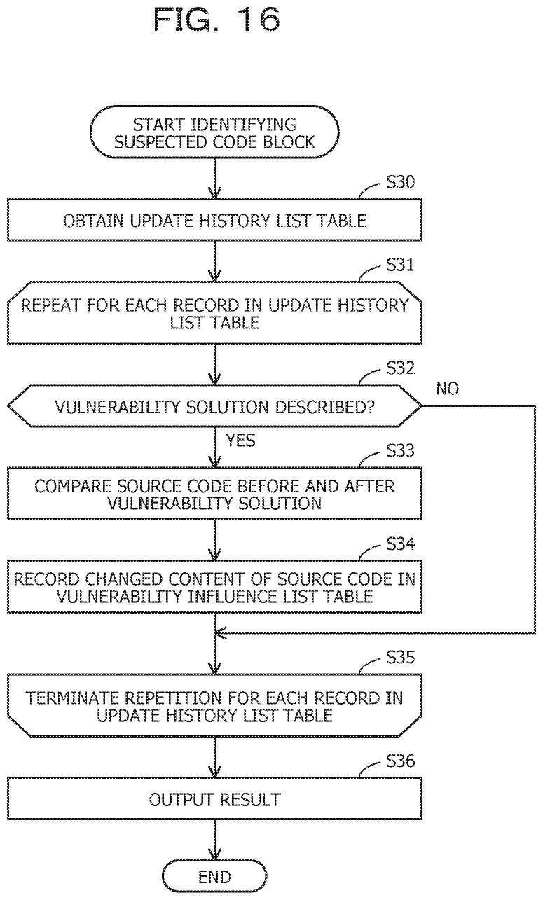

FIG. 16 is a flowchart illustrating an example of the suspected code block identification process. The suspected code block identification process corresponds to operation S14.

(S30) The development history information obtaining unit 130 obtains the update history list table 114. For example, the development history information obtaining unit 130 generates the update history list table 114 based on the update history information and the development history information stored in the storage unit 110 and stores the update history list table 114 in the storage unit 110.

(S31) For each record in the update history list table 114, the tree information creation unit 140 repeatedly executes operations S32 to S34. However, for a certain record, operations S33 and S34 may be skipped depending on determination in operation S32.

(S32) Based on the vulnerability solution detection rule information 115, the tree information creation unit 140 determines whether there is description of solving of vulnerability in the comment of the record. In the case where there is the description of the solving of vulnerability, the processing proceeds to operation S33. In the case where there is no description of the solving of vulnerability, the processing proceeds to operation S35. As described above, in the determination on the description of the solving of vulnerability, the tree information creation unit 140 may refer to the overview of the vulnerability of the corresponding OSS in the vulnerability table 111 or the vulnerability list table 113 based on the vulnerability solution detection rule information 115.

(S33) By comparing the source code reflecting an update of the record including the description of the solving of vulnerability with the source code at the time of an update immediately previous to the update of the record including the description of the solving of vulnerability in the update history list table 114, the tree information creation unit 140 obtains changed contents of the source code. The changed contents of the source code include information indicative of a suspected code block deleted by the update and a code block added by the update.

(S34) The tree information creation unit 140 records the changed contents of the source code obtained in operation S33 in the vulnerability influence list table 116. The tree information creation unit 140 generates the fixation file 117 indicative of the changed contents of the source code and records a path name to the fixation file 117 in the vulnerability influence list table 116.

(S35) Upon completion of the repeated execution for all the records in the update history list table 114, the tree information creation unit 140 causes the processing to proceed to operation S36.

(S36) The tree information creation unit 140 outputs a result. For example, the tree information creation unit 140 saves to the storage unit 110 the vulnerability influence list table 116 generated as the result of the processing of operations S31 to S35. The suspected code block identification process ends.

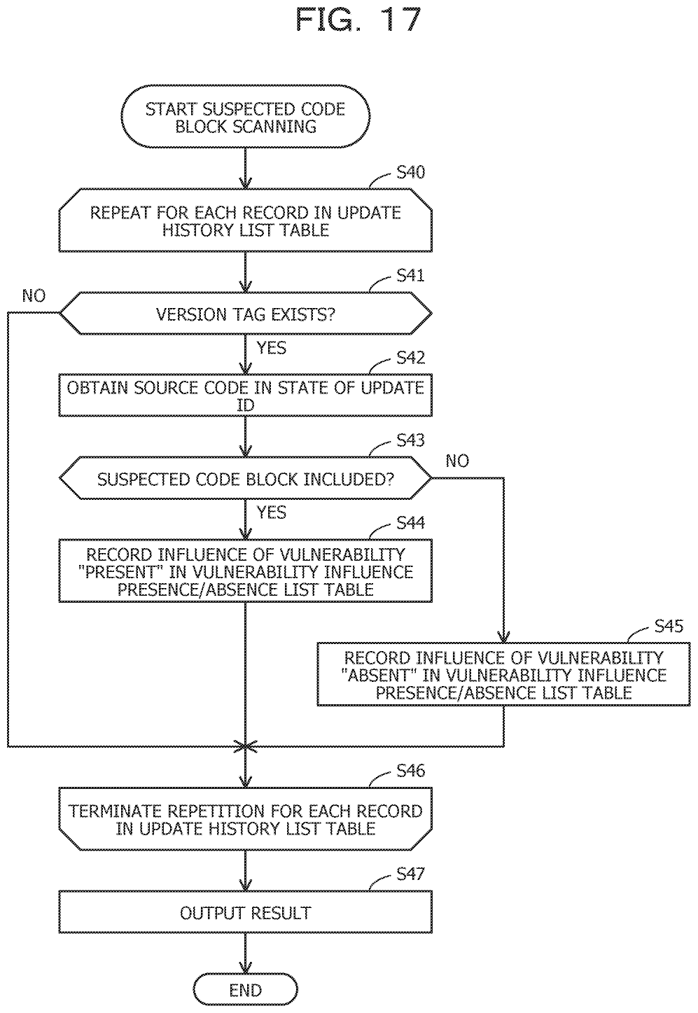

FIG. 17 is a flowchart illustrating an example of the suspected code block scanning process. The suspected code block scanning process corresponds to operation S15.

(S40) For each record in the update history list table 114, the tree information creation unit 140 repeatedly executes operations S41 to S45. However, for a certain record, a subset of the operations may be skipped depending on determination in operation S41 or S43.

(S41) The tree information creation unit 140 determines whether a version tag exists in the record. The version tag corresponds to a value set in the item of version in the update history list table 114. In the case where the setting of version exists in the item of version, it means that the version tag exists, and in the case where the setting of version does not exist in the item of version, it means the version tag does not exist. In the case where the version tag exists, the processing proceeds to operation S42. In the case where the version tag does not exist, the processing proceeds to operation S46.

(S42) The tree information creation unit 140 obtains a set of source code in the state of the update ID of the record. The set of source code in the state of the update ID is a set of source code at a time when a commit corresponding to the update ID is performed.

(S43) Based on the vulnerability influence list table 116, the tree information creation unit 140 obtains the suspected code block. The tree information creation unit 140 determines whether the set of source code obtained in operation S42 includes the suspected code block. In the case where the suspected code block is included, the processing proceeds to operation S44. In the case where the suspected code block is not included, the processing proceeds to operation S45.

(S44) The tree information creation unit 140 records, for the corresponding version, the influence of vulnerability of “PRESENT” in the vulnerability influence presence/absence list table 118. The processing proceeds to operation S46.

(S45) The tree information creation unit 140 records, for the corresponding version, the influence of vulnerability of “ABSENT” in the vulnerability influence presence/absence list table 118. The processing proceeds to operation S46.

(S46) Upon completion of the repeated execution for all the records in the update history list table 114, the tree information creation unit 140 causes the processing to proceed to operation S47.

(S47) The tree information creation unit 140 outputs a result. For example, the tree information creation unit 140 saves to the storage unit 110 the vulnerability influence presence/absence list table 118 generated as the result of the processing of operations S40 to S46. The suspected code block scanning process ends.

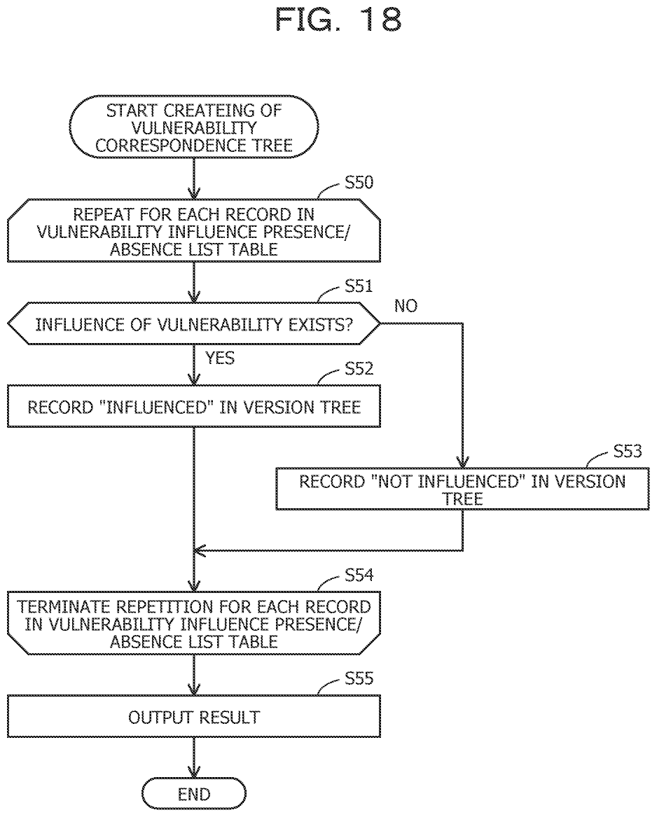

FIG. 18 is a flowchart illustrating an example of the vulnerability correspondence tree creation process. The vulnerability correspondence tree creation process corresponds to operation S16.

(S50) For each record in the vulnerability influence presence/absence list table 118, the tree information creation unit 140 repeatedly executes operations S51 to S53. However, for a certain record, a subset of operations may be skipped depending on determination in operation S51.

(S51) The tree information creation unit 140 determines whether the influence of vulnerability exists in the version of the record in the vulnerability influence presence/absence list table 118. In the case where the influence of vulnerability exits, the processing proceeds to operation S52. In the case where the influence of vulnerability does not exist, the processing proceeds to operation S53.

(S52) For the corresponding version in the version tree 400, the tree information creation unit 140 records “influenced”. The processing proceeds to operation S54.

(S53) For the corresponding version in the version tree 400, the tree information creation unit 140 records “not influenced”. The processing proceeds to operation S54.

(S54) Upon completion of the repeated execution for all the records in the vulnerability influence presence/absence list table 118, the tree information creation unit 140 causes the processing to proceed to operation S55.

(S55) The tree information creation unit 140 outputs a result. For example, the tree information creation unit 140 outputs to the display control unit 150 information of the vulnerability correspondence tree display screen 500 including the version tree 400 created in the processing of operations S50 to S54. The vulnerability correspondence tree creation process ends.

As described above, the display control unit 150 may prompt the user to check the version under the influence of the vulnerability by highlighting the version “influenced” by the vulnerability in the vulnerability correspondence tree display screen 500.

Meanwhile, in recent years, as demand for use of the OSS has been increasing, a risk caused by vulnerability due to use of the OSS for software products has been increasing. Although a quick response to detected vulnerability is desired, in the case of the OSS, the following problems arise, and the degree of difficulty in remediating vulnerability is relatively high.

First, since remediation for the OSS is made by upgrading of the version, it is desirable to identify the vulnerability remediated version. The reason for this is that the OSS does not provide a so-called patch that solves only vulnerability without influencing the version in use.

Second, there are many cases where a plurality of versions of the OSS are developed in parallel and released, and the degree of difficulty in identifying the vulnerability remediated version is high.

Third, since the OSS project itself may fork (branch), there is a possibility that an influence range expands to other OSS.

Fourth, in the case where vulnerability is found in a certain version of certain software by a security organization, it is desired to wait for reproduction testing for the individual versions regarding whether the other versions are under the influence. Thus, the influence range is not necessarily quickly identified.

Fifth, in the case of the OSS, since a project itself may fork, there may be a case where a suspected location in the source code is copied to another project. However, this influence range is not necessarily quickly identified, either.

Sixth, regarding versions subsequent to the vulnerability target version, a suspected location in the source code may have been erased through refactoring or the like. However, whether the vulnerability has been solved is not necessarily determined without checking the behavior by reproduction testing or the like.

For example, regarding the software A represented by the version tree 400, a case is considered where the fact that the vulnerability has been found in version “1.1.0” is publicized. In this case, the influence range of the vulnerability in not necessarily identified without performing the reproduction testing on the previous version (1.0.0), the subsequent versions (1.2.0, 1.3.0, 1.4.0), the branched versions (2.0.0 and 3.0.0), and all the versions of the branched software B.

As described above, in the case where the reproduction testing is performed, a case is conceivable where the presence/absence of the influence on the other versions is different depending on whether the suspected location of the source code of the version having the vulnerability is mixed in the source code of the other versions. In order to remediate the vulnerability of the OSS, the presence/absence of the influence for each version is checked. However, performing the reproduction testing for all the versions demand many resources in both a storage area for the source code and the time until the completion of the reproduction testing.

Accordingly, as described in the second embodiment, the information processing apparatus 100 enables identification of the presence/absence of the influence of vulnerability in each version without performing reproduction testing on all the versions, for example. Thus, the information processing apparatus 100 may efficiently determine the version including vulnerability.

For example, the information processing apparatus 100 executes the following processing. The development history information obtaining unit 130 obtains update history information including respective update histories of a plurality of versions of software. The tree information creation unit 140 identifies from the update history information a second version corresponding to an update history including a predetermined keyword. Based on development history information including a change location in source code of the software between the identified second version and a first version immediately previous to the identified second version, the tree information creation unit 140 identifies, as a code block that has a possibility of including vulnerability (a suspected code block), a code block deleted from the source code when the first version is upgraded to the second version. The tree information creation unit 140 detects, out of the plurality of versions, a version including the identified code block in the source code.

Accordingly, the information processing apparatus 100 may efficiently determine a version including the vulnerability. The update history information and the development history information are reflected in the update history list table 114. Thus, the update history list table 114 is examples of the update history information and the development history information. Information registered in the item of the comment of the update history list table 114 is an example of the above-described update history.

In the identifying of the second version, the tree information creation unit 140 determines whether the update history of each of the plurality of versions includes any of a plurality of keywords which indicate that a security problem in the software has been solved. The tree information creation unit 140 identifies, as the second version, a version corresponding to an update history including any of the plurality of keywords.

Thus, the information processing apparatus 100 may appropriately identify a version in which the vulnerability has been solved. Character strings to be detected in each rule content of the vulnerability solution detection rule information 115 are examples of the above-described keywords.

The tree information creation unit 140 may obtain identification information that identifies the vulnerability found with respect to the software or that identifies an attack which exploits the vulnerability, and the tree information creation unit 140 may determine, as the predetermined keyword, a keyword that includes the identification information.

Thus, the information processing apparatus 100 may appropriately identify the version in which the vulnerability has been solved. For example, it is conceivable that the tree information creation unit 140 extracts the identification information such as “XSS” in the overview of the vulnerability table 111 or the vulnerability list table 113 as is the case with the rule content of the rule number “3” in the above-described vulnerability solution detection rule information 115. The tree information creation unit 140 may set the extracted identification information as the keyword to be used for comparison with the update history.

Based on the development history information, the tree information creation unit 140 identifies a version of other software that has been created from a derivative of the software, and the tree information creation unit 140 detects a version of the other software including the identified code block in source code.

Thus, the information processing apparatus 100 may efficiently determine the version including the vulnerability also for the other software that has been created from the derivative of the software.

The display control unit 150 causes a display device to display a screen representative of an order relationship between the plurality of versions and to highlight on the screen the version including the identified code block in the source code out of the plurality of versions.

Thus, the information processing apparatus 100 may appropriately present to the user the version which is the checking target for the vulnerability and may prompt the user to check the vulnerability. For example, the user may select a version without the influence of the vulnerability other than the version under the influence of the vulnerability and use the selected version for software development. Alternatively, the user may focus on the version that is displayed as a version under the influence of the vulnerability and set the focused version as a target of an operational check such as reproduction testing. In this way, the information processing apparatus 100 may decrease work load of the user in checking vulnerability.

The display 51 is an example of the display device. The display device may be a device coupled to another information processing apparatus that communicates with the information processing apparatus 100 via the network 50. The vulnerability correspondence tree display screen 500 is an example of the screen displayed on the above-described display device.

In the detecting of the version that includes the identified code block in the source code, the tree information creation unit 140 detects all versions that includes the identified code block in the source code. Thus, the information processing apparatus 100 may identify the versions that possibly include the vulnerability without omission.

Information processing according to the first embodiment may be realized by causing the processing unit 12 to execute a program. Information processing according to the second embodiment may be realized by causing the CPU 101 to execute the program. The program may be recorded in the computer-readable recording medium 53.

For example, the program may be distributed by distributing the recording medium 53 in which the program is recorded. The program may be stored in another computer and distributed via a network. For example, the computer may store (install) the program recorded in the recording medium 53 or received from another computer in a storage device such as the RAM 102 or the HDD 103, read the program from the storage device, and execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
obtaining update history information that includes respective update histories of a plurality of versions of software, the plurality of versions including a first version immediately previous to a second version;
identifying, from the update history information, the second version that corresponds to the update history that includes a predetermined keyword;
identifying, based on development history information that includes a change location in a source code of the software between the first version and the second version, a code block deleted from the source code when the first version is upgraded to the second version, as the code block that includes a possibility of including vulnerability; and
detecting, out of the plurality of versions, a third version that includes the identified code block in the source code.

2. The non-transitory computer-readable recording medium according to claim 1, wherein, in the identifying of the second version, whether the update history of each of the plurality of versions includes any of a plurality of keywords that indicate that a security problem in the software has been solved is determined, and a fourth version that corresponds to the update history that includes any of the plurality of keywords is identified as the second version out of the plurality of versions.

3. The non-transitory computer-readable recording medium according to claim 1, the process further comprising:
obtaining identification information that identifies the vulnerability found with respect to the software or that identifies an attack that exploits the vulnerability; and
determining, as the predetermined keyword, a keyword that includes the identification information.

4. The non-transitory computer-readable recording medium according to claim 1, the process further comprising:
identifying, based on the development history information, a fifth version of other software that has been created from a derivative of the software; and
detecting the fifth version of the other software that includes the identified code block in the source code.

5. The non-transitory computer-readable recording medium according to claim 1, the process further comprising:
causing a display device to display a screen representative of an order relationship between the plurality of versions and to highlight on the screen the third version.

6. The non-transitory computer-readable recording medium according to claim 1, wherein, in the detecting of the third version, all third versions that include the identified code block in the source code are detected.

7. A method of detecting vulnerability for causing a computer to execute a process, the process comprising:
obtaining update history information that includes respective update histories of a plurality of versions of software, the plurality of versions including a first version immediately previous to a second version;
identifying, from the update history information, the second version that corresponds to the update history that includes a predetermined keyword;
identifying, based on development history information that includes a change location in a source code of the software between the first version and the second version, a code block deleted from the source code when the first version is upgraded to the second version, as the code block that includes a possibility of including vulnerability; and
detecting, out of the plurality of versions, a third version that includes the identified code block in the source code.

8. An information processing apparatus comprising:
a memory configured to store update history information that includes respective update histories of a plurality of versions that include a first version immediately previous to a second version and development history information that includes a change location in a source code of the software between the first version and the second version; and
a processor coupled to the memory and configured to
identify, from the update history information, the second version that corresponds to the update history that includes a predetermined keyword,
identify, based on the development history information, a code block deleted from the source code when the first version is upgraded to the second version, as a code block that includes a possibility of including vulnerability, and
detect, out of the plurality of versions, a third version that includes the identified code block in the source code.
